(19) United States
(12) Patent Application Publication
(10) Pub. No.: US 2004/0237390 A1
(43) Pub. Date: Dec. 2, 2004

(54) Anti-tangling plant pot

(76) Inventor: Laurent Clop, Loriol Du Contat (FR)

Correspondence Address: Kasper & Laughlin, 13 Forest Drive, Warren, NJ, 07059, US

(21) Appl. No.: 10/480,178

(22) PCT Filed: Jun. 7, 2002
(86) PCT No.: PCT/FR02/02078

(30) Foreign Application Priority Data
Jun. 8, 2001 (FR) 0107533

(51) Int. Cl. A01G 13/02

(52) U.S. Cl. 47/32.7

(57) ABSTRACT

The present invention relates to a plant pot comprising a hollow frustoconical body (1) tapering from its top edge towards its bottom edge, the body including at least two guide ribs (3). The pot further comprises a concave base (4) having a vertex (8) that points away from said top edge. Furthermore, the disposition of aeration and drainage holes (6) which are in contact with the air which flows between the bottom of the pot and the ground, causes the roots to dry and thus prevents them from tangling.

The present invention relates to an anti-tangling plant pot that makes it possible to prevent the formation of root tangling on ornamental nursery plants, forest nursery plants, fruit nursery plants, wine growing nursery plants, horticultural-production plants, and hydroponic plants, regardless of whether the pot is round or square and whatever its volume.

Regardless of capacity, all pots (also known as “containers”) are round or square. The pot shape most widely used is round having vertical sides that slope at a few degrees (a frustoconical shape), with or without water drainage and aeration holes at the bottom of the vertical sides. They have a round flat-bottomed base in contact with the ground, presenting drainage holes and shapes making it possible to improve water drainage capacity and aeration at the bottom of the pot. Between the vertical sides and the horizontally-positioned bottom of the pot, the round shape makes an angle close to ninety degrees, which value varies from one model to another.

The other pot shape most widely used is square having vertical sides that slope at a few degrees, with or without water drainage and aeration holes at the bottom of the vertical sides, and a square flat-bottomed base presenting drainage holes and shapes making it possible to improve water drainage capacity and aeration at the bottom of the pot. Between the vertical sides and the bottom of the pot, which is positioned horizontally and in contact with the ground, the square shape makes an angle close to ninety degrees. In addition, at each corner where two vertical sides join, the square shape includes an angle of ninety degrees which, depending on the model, is more or less rounded in its shape.

Whatever the pot shape used, when a plant is grown in one of these pots, the growth of the aerial portion of said plant takes place correctly. The same does not apply to its root system. In nature, plants, from their birth (germination of seeds, natural layering, natural suckering), form a vertically-descending main root known as a “tap root”. The “tap root” has the function of quickly anchoring the plant to the soil and, by growing downwards, of dipping into the water reserves that are present deep in said soil. Once the “tap root” is sufficiently formed, the plant develops a horizontal root system close to the surface of the soil so as to absorb rain water during average or light rainfall. The “tap root” and the horizontal root system continue to develop throughout the entire life of the plant.

In a pot plant, the soil is replaced by an artificial or natural substrate which has the capacity to retain a portion of rain or watering water, and which has high porosity which enables roots to be aerated, excess water to be evaporated, and surplus water that the substrate cannot retain to be evacuated through drainage holes. Excess water is prejudicial to the survival of any plant in a container. A plant grown in a pot thus has a volume of substrate that is small compared to natural conditions. It colonizes said space to as great an extent as possible as if it were in nature, by trying to develop its root system in the way described above.

The first factor limiting harmonious and natural development of the root system is the bottom of the pot. The plant encounters the bottom very quickly. On making contact with this obstacle, continuity of the natural vertical development of the “tap root” is prevented. Since the bottom of the pot is horizontally positioned perpendicularly to the vertical axis of the “tap root”, the “tap root” forms an angle of ninety degrees by following the bottom of the pot. Then, the “tap root”, which has thus become horizontal, reaches the angle where the vertical sides of the (round or square) pot join the bottom of the (round or square) pot that the root has been following.

At this point, two outcomes are possible:

the tap root may rise vertically along the vertical sides of the pot, and on reaching the surface it will lose its deep anchoring and underground-water absorption functions; or

by following the angle formed between the vertical sides and the bottom of the (round or square) pot horizontally, the tap root may make one or more turns around the pot, thus creating one or more coils about the vertical axis of said tap root. The phenomenon created in this way is known as “root tangling”.

The second factor limiting the harmonious and natural development of the root system of the plant grown in a (round or square) pot is the horizontal root system reaching the vertical sides of the container which, on making contact, prevent continued natural development thereof.

At this point, two outcomes are possible:

the horizontal root system forms an angle of ninety degrees and follows the sides of the pot down towards the bottom of the pot. It thus meets the developing tap root as explained above for the first limiting factor concerning the “tap root”; or

the horizontal root system continues to develop horizontally by following the vertical sides of the (round or square) pot in horizontal manner. By following the sides, the roots thus make one or more turns around the (round or square) pot. By coiling about the vertical axis of the “tap root”, the horizontal root system likewise creates the phenomenon known as “root tangling”.

In the end, the phenomenon of “root tangling” poses the following various problems:

said phenomenon continues irreversibly when the plant is planted out in soil without the pot, even if the planter splits the substrate ball on planting out in order to provoke ramification of the roots existing in the substrate ball;

bad anchoring of the plant in the soil where it is planted out since the tap root no longer fulfills its role of fixing the plant deep in the soil. Consequently, there is a well-known risk of the plant falling over when, as a result of its badly developed root system, the volume of its foliage becomes too large for the soil to support the stresses associated with the mass of foliage and bad weather;

the plant has poor capacity to absorb water present deep in the soil as a result of the absence of a correctly developed “tap root”. It is therefore absolutely essential to increase artificial watering;

the plant has poor capacity to absorb water present on the surface remote from said plant, since the horizontal root system remains coiled, despite a few ramifications subsequent to its being planted out that never achieve the performances of a “tangle-free” horizontal root system. Dependency on an artificial watering system is therefore increased; and

premature death of the plant associated with the phenomenon of its roots tangling, which roots, by increasing in diameter, with increasing age of the plant, end up by completely strangling the tap root and thus cutting off the flow of sap, causing the sudden death of the plant even though said plant seems healthy and growing.

The device of the invention makes it possible to remedy the problems of unnatural development of the horizontal root system and of the “tap root” system inside a round or square pot of ordinary shape.

In the invention, a plant pot comprises a hollow body, the body including at least two guide ribs; in addition the pot comprises a concave base having a vertex that points away from the top edge.

The periphery of the concave base is advantageously connected to the body above its bottom edge, so that said concave base is contained completely inside the frustoconical body.

Preferably, at least two directing ribs are provided on the top face of the concave base.

According to another characteristic, the directing ribs are connected to the guide ribs.

Furthermore, all the points of the concave base present a slope of the same sign.

Preferably, the body is frustoconical in shape and its section optionally tapers from its top edge towards its bottom edge.

The present invention appears below in greater detail in the context of the following description of embodiments given by way of illustration and with reference to the accompanying figures, in which:

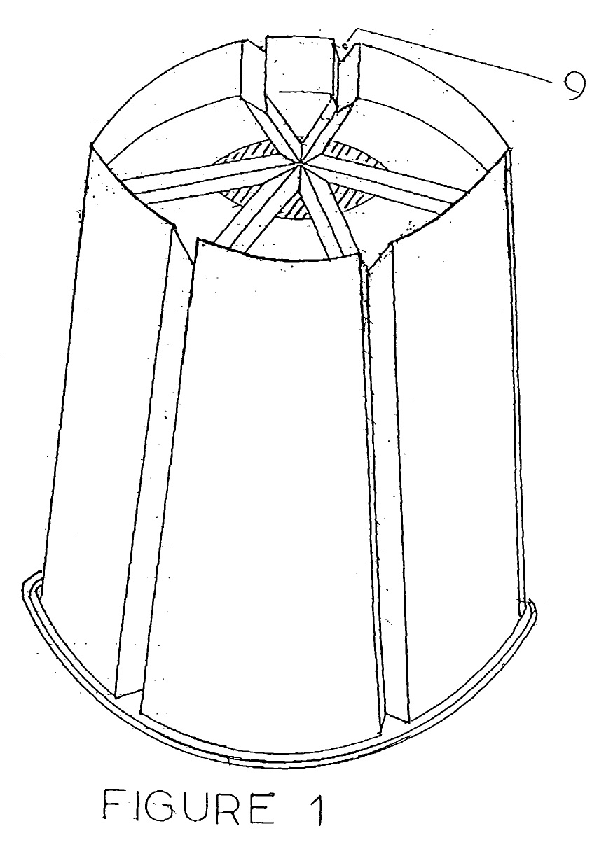

FIG. 1 is a perspective view of a preferred embodiment of a plant pot;

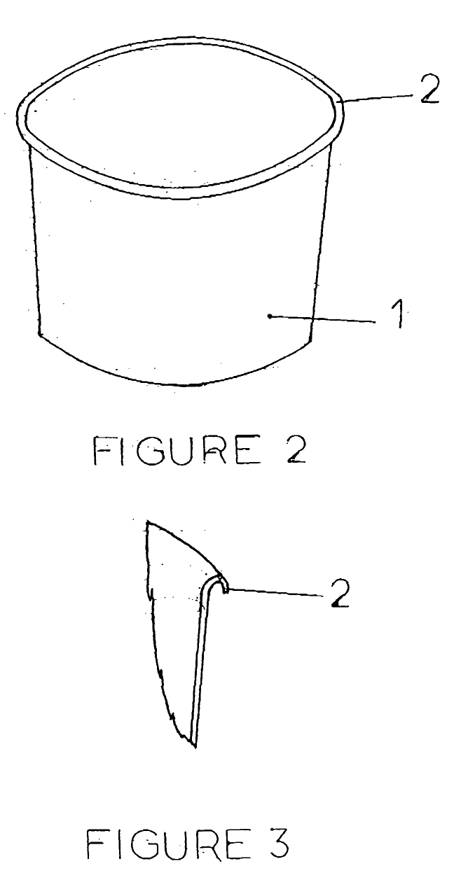

FIG. 2 is a diagrammatic view of a frustoconical body;

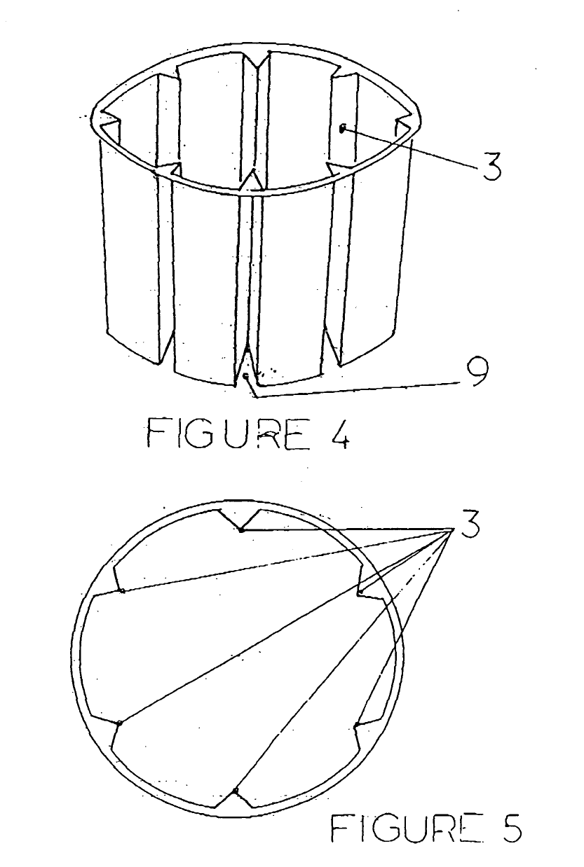

FIG. 3 is a detailed view of a lip of the body;

FIG. 4 is a detailed perspective view of a frustoconical body;

FIG. 5 is a plan view of the frustoconical body;

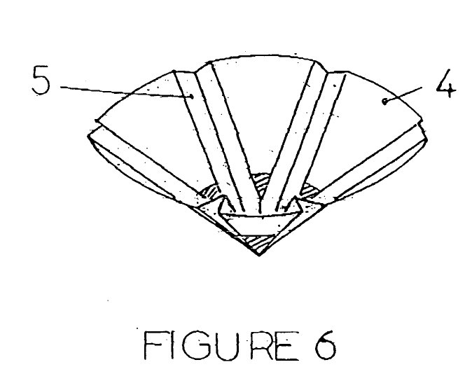

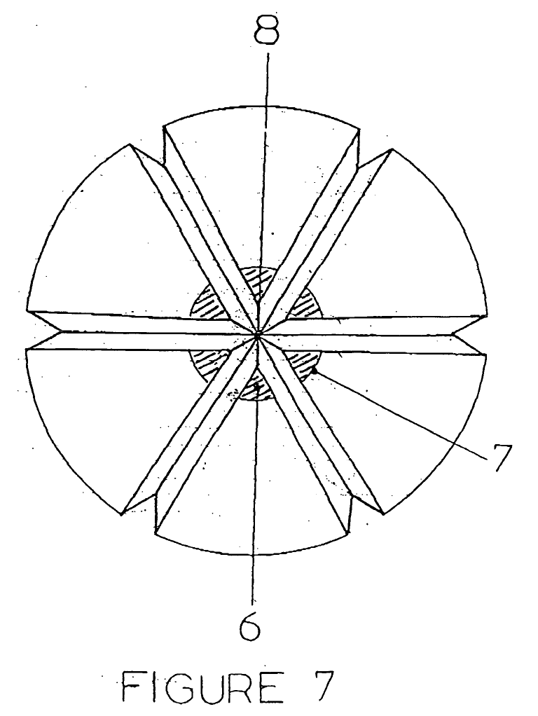

FIG. 6 is a perspective view of a concave base;

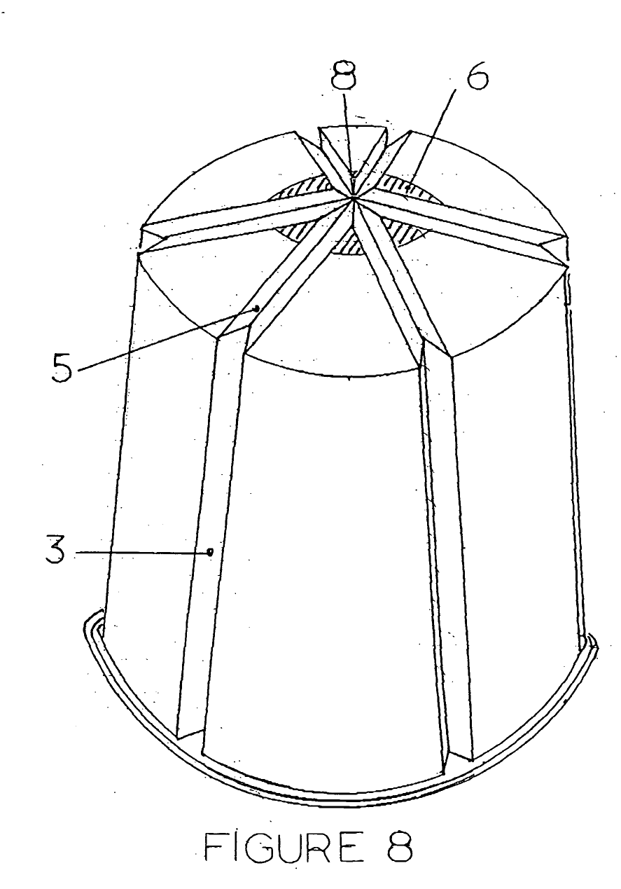

FIG. 7 is a plan view of said concave base;

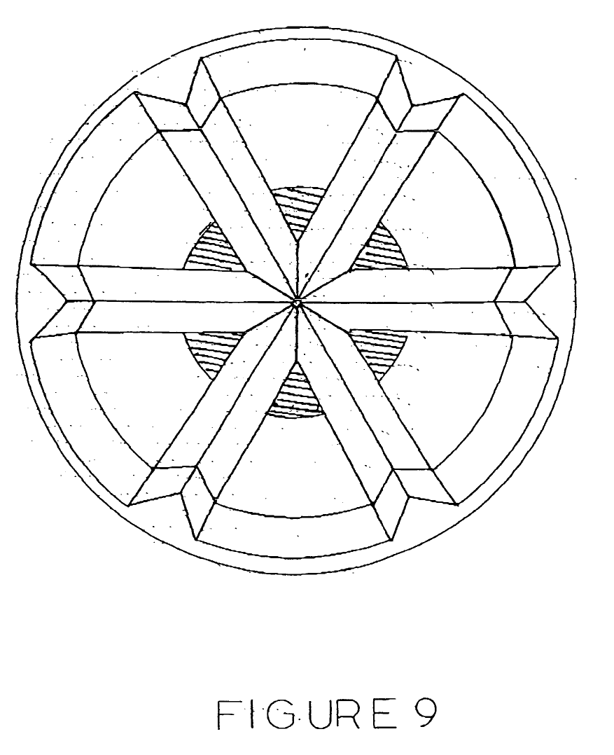

FIG. 8 is a perspective view of another embodiment of the plant pot; and

FIG. 9 is a plan view of the base of said other embodiment.

Elements which appear in more than one of the figures are given the same reference in each of them.

With reference to FIG. 2, in a round embodiment of the plant pot of the present invention, it is necessary to start with a hollow frustoconical body 1. A lip 2 is often provided on the top edge of the frustoconical body, which lip is rounded and curved outwards and downwards, and is shown in greater detail in FIG. 3.

With reference to FIGS. 4 and 5, the frustoconical body includes, on its periphery, at least two guide ribs 3 extending from the top edge to the bottom edge of the frustoconical body 1 along a substantially vertical axis. The ribs project into the frustoconical shape. By way of example, the frustoconical body could present six guide ribs 3, the ribs including, at their respective bottom edges, openings 9 enabling air to flow. The openings 9 also appear in FIG. 1.

The ribs 3 enable the roots constituting the horizontally-developing root system to be guided downwards, whatever the height of the zone in which the roots make contact with the frustoconical body 1.

With reference to FIGS. 6 and 8, the bottom of the plant pot is constituted by a conical base 4 having a pointed portion or vertex 8 that points down towards the ground.

On its top face, the conical base 4 is provided with at least two directing ribs 5 which extend from its periphery to its center. The directing ribs are preferably connected to the guide ribs 3 of the frustoconical body.

By way of example, the conical base could present six directing ribs 5.

Holes 6 are provided between adjacent directing ribs 5, said holes being almost triangular in shape, with the side of each hole that is remote from the center of the conical base 4 being rounded. In this case, the holes are shown at the junctions between the ribs, but they could be disposed elsewhere, and in greater number depending on their size.

With reference to FIG. 1, the periphery of the conical base 4 is connected to the frustoconical body 1 above its bottom edge, so that the vertex 8 of the conical base does not come into contact with the ground.

The fact that the holes 6 are situated in the lowest portion of the conical base 4 imparts the following features:

it improves the evacuation of excess water in the substrate and also improves aeration of the substrate inside the pot compared to conventionally-shaped pots having drainage holes that are in contact with the ground. Since drainage and aeration of the substrate are improved, colonization of the substrate by the roots is increased; and

by contact with the air present between the bottom of the conical base and the ground, it dries the ends of the roots which are presented at the only possible outlets as constituted by the holes 6, thus preventing said roots from becoming any longer, without said roots being able to become “tangled”.

Drying in this way allows the roots to ramify, which ramifications, on growing, are in turn presented to one of the holes, thus creating a root system which does not present “root tangling”.

The directing ribs 5 present the following technical advantages:

roots are continuously guided towards the bottom of the frustoconical body by the ribs present in said body; and

on the conical base that constitutes the bottom of the pot, the roots are guided towards the holes that are present at the periphery of the junctions between the ribs at the bottom of the conical shape.

With reference to FIG. 7, the junction between the ribs on the conical base presents significant technical advantages in the functioning of the present invention:

a geometrical shape which necessarily guides the roots towards the holes present at the periphery of said geometrical shape; and

a geometrical shape which creates a support for the substrate, which substrate, despite the holes, does not leave the pot while it is being filled or during plant growth, whatever the volume of the pot.

The base 4 described above as being conical in shape could be of any other shape provided it is concave. Thus, a spherical cap, a circularly symmetrical parabolic cap, or even any other shape that does not present axial symmetry is suitable.

In addition, all the points of the concave base 4 present a slope of the same sign, i.e. a slope that is negative, so that gravity attracts any element towards the bottom of the base where the holes 6 are provided.

In addition, the body 1 described above as being frustoconical in shape could be of any other shape. Thus, a body of square section is quite suitable, and if the section tapers from its top edge to its bottom edge, a plurality of pots can be stacked easily one in another.

To make such stacking even easier, various slots or openings can be provided in the body or in the base without going beyond the ambit of the present invention.

In the embodiment of the present invention, there is no material behind the guide ribs. Said ribs are formed integrally.

Advantageously, the pot which is the subject of the present invention is made as a single piece.

1. A plant pot comprising a hollow body (1) and a concave base 4, having a vertex (8) that points away from the top edge of said bode,
the body including at least two guide ribs (3),
the pot being characterized in that the periphery of said concave base (4) is connected to said body (1) above its bottom edge, so that said concave base is contained completely inside the body.

2. A plant pot according to claim 1, characterized in that at least two directing ribs (5) are provided on the top face of said base (4).

3. A plant pot according to claim 2, characterized in that said directing ribs (5) are connected to said guide ribs (3).

4. A plant pot according to claim 1, characterized in that all the points of said concave base (4) present a slope of the same sign.

5. A plant pot according to any preceding claim 1, characterized in that body (1) is frustoconical in shape.

6. A plant pot according to claim 1,
